(19) United States
(12) Patent Application Publication
(10) Pub. No.: US 2026/0342250 A1
(43) Pub. Date: Oct. 29, 2026

(54) POWER GENERATION SYSTEM AND METHOD

(71) Applicants: World Treasure Green Energy Co. Ltd., Hualien County (TW); J-LIDA ENTERPRISE CO., LTD., New Taipei City (TW)

(72) Inventor: ZHI-HAO CHANG, Hualien County (TW)

(21) Appl. No.: 19/110,834

(22) PCT Filed: Sep. 14, 2022
(86) PCT No.: PCT/CN2022/118669

§ 371 Date: Mar. 12, 2025

(51) Int. Cl. H02P 7/347; F16H 1/28

(52) U.S. Cl. CPC H02P 7/347; F16H 1/28

(57) ABSTRACT

A power generation system comprises an activation apparatus, a rotation assembly, an electricity generating module, an AC/DC converter circuit, a DC/DC Step-Down converter circuit, a capacitor module, a motor controller, and an electric motor. The rotation assembly is activated by the activation apparatus to drive the electricity generating module. The generated electricity charges the capacitor module after reducing voltage. The capacitor module provides the power to drive the electric motor through the motor controller. The electric motor drives the rotation assembly to rotate.

### BACKGROUND OF THE INVENTION

### 1. Field of the Invention

The invention relates to a power generation system and method thereof, especially to a portable power generation system and method thereof.

### 2. Description of the Prior Art

The conventional portable power generator needs to supply fuel, such as gasoline, liquefied petroleum gas, or natural gas. Once there is fuel supply shortage, the portable power generator stops working. It is necessary to provide the portable power generator for more convenient use.

### SUMMARY OF THE INVENTION

In an embodiment, the present invention provides a power generation system, comprising:
an activation apparatus;
a rotation assembly, activated by the activation apparatus;
an electricity generating module, driven by the rotation assembly to generate alternating current;
an AC/DC converter circuit, converting the alternating current to direct current, wherein the direct current comprises a conversion voltage;
a DC/DC Step-Down converter circuit, receiving the direct current, reducing the conversion voltage, and outputting a charging voltage;
a capacitor module, receiving the charging voltage for constant voltage charging;
a motor controller, electrically connected to the capacitor module; and
an electric motor, electrically connected to the motor controller to drive the rotation assembly.

In an embodiment, the present invention provides a method for power generation, comprising:
providing an activation rotational speed as an input rotational speed of a rotation assembly;
amplifying the input rotational speed by the rotation assembly to provide an output rotational speed;
generating alternating current through the output rotational speed;
converting the alternating current to direct current;
using the direct current to constant-voltage charging a capacitor module;
driving an electric motor by electricity coming from the capacitor module;
replacing the activation rotational speed with a constant rotational speed, provided by the electric motor, as the input rotational speed.

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein:

FIG. 1 illustrates a diagram of a power generation system.

FIG. 2 illustrates a diagram of a rotation assembly.

FIG. 3 illustrates a flowchart of a method for power generation.

### DETAILED DESCRIPTION OF THE PREFERRED EMBODIMENTS

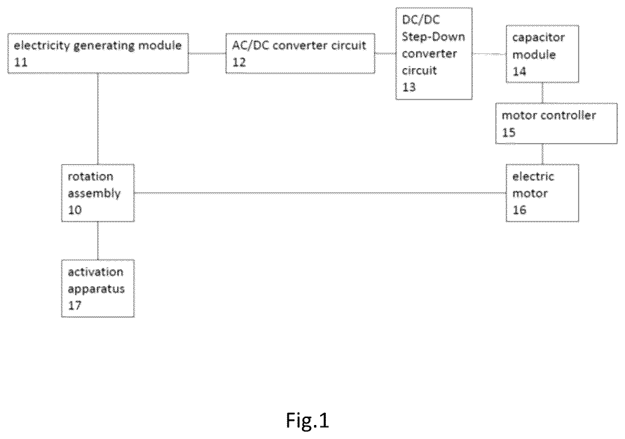

Referring to FIG. 1, in an embodiment, a power generation system comprises a rotation assembly 10, an electricity generating module 11, an AC/DC converter circuit 12, a DC/DC Step-Down converter circuit 13, a capacitor module 14, a motor controller 15, an electric motor 16, and an activation apparatus 17.

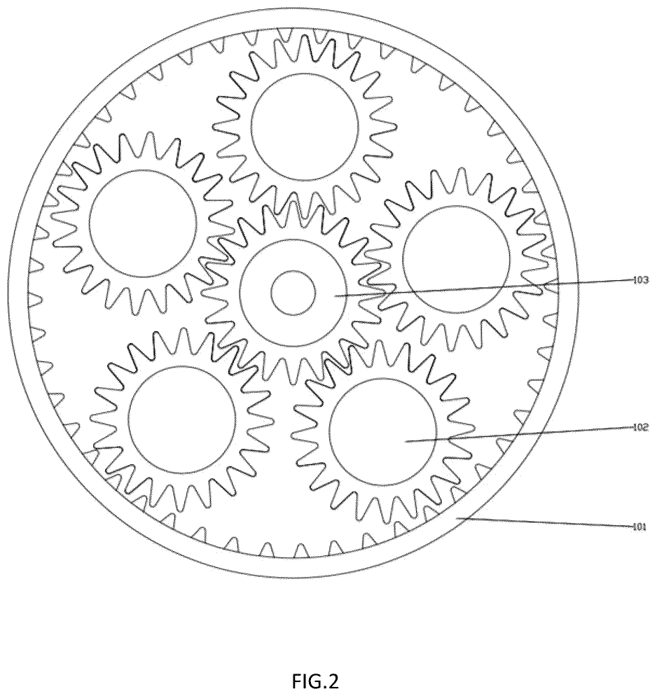

Referring to FIG. 2, in an embodiment, the rotation assembly 10 comprises an outer ring gear 101, five planetary gears 102, and a center gear 103. The rotation assembly 10 is capable of amplifying the input rotational speed several times to produce the output rotational speed. The radiuses of the planetary gears 102 and center gear 103 are smaller than the radius of the outer ring gear 101. The center gear 103 is disposed at the center of the outer ring gear 101 and engaged with the planetary gears 102. The planetary gears 102 engage with the outer ring gear 101. The outer ring gear 101 drives the planetary gears 102, and the planetary gears 102 drive the center gear 103. The rotational speed of the center gear 103 is capable of being faster than the rotational speed of the outer ring gear 101, such as 4~8 times faster.

In an embodiment, the outer ring gear 101, the planetary gears 102, and the center gear 103 all comprise the helical gears.

In an embodiment, the rotation assembly 10 starts rotating after the activation apparatus 17, such as the activation pull cord, is pulled by hand. The rotation assembly 10 drives the electricity generating module 11 via the center gear 103. In an embodiment, the electricity generating module 11 generates three-phase alternating current. The three-phase alternating current is converted to the direct current via the AC/DC converter circuit 12, such as the bridge rectifier. The direct current comprises a conversion voltage. Compared with the outer ring gear 101 (or the front wheel of a electrical motorcycle), the rotational speed of the center gear 103 increases several times. Therefore, after rectifying, the conversion voltage of the alternating current generated by the electricity generating module 11, with very high probability, is higher than the required charging voltage of the capacitor module 14 when charging the capacitor module 14 in the constant-voltage mode.

The DC/DC Step-Down converter circuit 13 receives the inputted direct current, decreases the conversion voltage, and outputs the required charging voltage of the constant-voltage charging mode for the capacitor module 14. In an embodiment, the DC/DC Step-Down converter circuit 13 comprises a backflow protection circuit. The backflow protection circuit is disposed at the input end of the DC/DC Step-Down converter circuit 13. The backflow protection circuit may comprise a capacitor.

In an embodiment, the capacitor module 14 comprises multiple supercapacitors in series and a power management circuit. The capacitor module 14 is capable of performing the function of constant-voltage charging. The charged capacitor module 14 may work as a power supply. The supercapacitors are electrostatic double-layer capacitors, capable of been charged faster than the conventional rechargeable batteries.

In an embodiment, the output direct current of the capacitor module 14 is converted to the three-phase sinusoidal alternating current via the motor controller 15. The three-phase sinusoidal alternating current is employed to drive the electrical motor 16. In an embodiment, the capacitor module 14 provides the direct current to drive the electrical motor 16 via the motor controller 15.

In an embodiment, the electrical motor 16 rotates at a constant rotational speed to drive the rotation assembly 10. Then, the constant rotational speed is amplified to drive the electricity generating module 11 for charging the capacitor module 14. A part of the stored electric power keeps providing the electricity for the electrical motor 16, and the rest of the electric power is for the external electricity users.

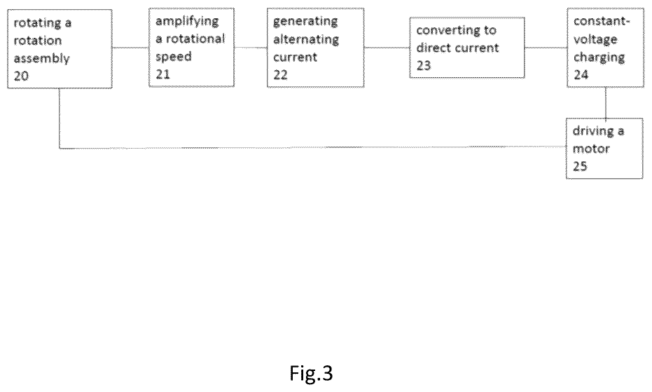

In an embodiment, referring to FIG. 3, a method for power generation comprises Step 20, rotating a rotation assembly, Step 21, amplifying a rotational speed, Step 22, generating alternating current, Step 23, converting to direct current, Step 24, constant-voltage charging, and Step 25, driving a motor.

In Step 20 and Step 21, in an embodiment, an activation pull cord is pulled by hand to generate the activation rotational speed. The activation rotational speed is used as the input rotational speed of a rotation assembly, and the rotation assembly starts rotating. The rotation assembly comprises an outer ring gear, five planetary gears, and a center gear. The center gear is disposed at the center of the outer ring gear and engaged with the planetary gears. The planetary gears 102 engage with the outer ring gear. The output rotational speed of the rotation assembly is capable of being faster than the activation rotational speed, such as 4~8 times faster. Multiple planetary gears are capable of decreasing the wear and tear caused by the engaging of the gears.

In Step 22, the output rotational speed is used to drive an electricity generating module for generating the three-phase alternating current.

In Step 23, the three-phase alternating current is converted to the direct current. In an embodiment, the voltage of the converted direct current is decreased.

In Step 24, the decreased voltage is used to charge a capacitor module. In an embodiment, the capacitor module comprises multiple supercapacitors in series and a power management circuit. The capacitor module is capable of performing the function of constant-voltage charging. The charged capacitor module may work as a power supply, and provide the electric power for the electric motor. The supercapacitors are electrostatic double-layer capacitors, capable of been charged faster than the conventional rechargeable batteries.

In Step 25, The capacitor module provides the electric power for driving the electric motor. In an embodiment, the electrical motor rotates at a constant rotational speed to drive the rotation assembly 10. The constant rotational speed may replace the activation rotational speed, and may be amplified for generating electric power.

What is claimed is:

1. A power generation system, comprising:
an activation apparatus;
a rotation assembly, activated by the activation apparatus;
an electricity generating module, driven by the rotation assembly to generate alternating current;
an AC/DC converter circuit, converting the alternating current to direct current, wherein the direct current comprises a conversion voltage;
a DC/DC Step-Down converter circuit, receiving the direct current, reducing the conversion voltage, and outputting a charging voltage;
a capacitor module, receiving the charging voltage for constant voltage charging;
a motor controller, electrically connected to the capacitor module; and
an electric motor, electrically connected to the motor controller to drive the rotation assembly.

2. The power generation system according to claim 1, wherein the rotation assembly comprises an outer ring gear, five planetary gears, and a center gear.

3. The power generation system according to claim 2, wherein the outer ring gear drives the planetary gears, and the planetary gears drive the center gear.

4. The power generation system according to claim 2, wherein the center gear drives the electricity generating module.

5. The power generation system according to claim 2, wherein the center gear is disposed at a center of the outer ring gear.

6. The power generation system according to claim 1, wherein the alternating current is three-phase alternating current.

7. The power generation system according to claim 1, wherein the DC/DC Step-Down converter circuit comprises a backflow protection circuit.

8. The power generation system according to claim 1, wherein the capacitor module comprises a power management circuit.

9. The power generation system according to claim 1, wherein the capacitor module comprises a plurality of supercapacitors in series.

10. The power generation system according to claim 1, wherein the activation apparatus comprises an activation pull cord.

11. The power generation system according to claim 1, wherein the motor controller is capable of controlling the electric motor to drive the rotation assembly at a constant rotational speed.

12. A method for power generation, comprising:
providing an activation rotational speed as an input rotational speed of a rotation assembly;
amplifying the input rotational speed by the rotation assembly to provide an output rotational speed;
generating alternating current through the output rotational speed;
converting the alternating current to direct current;
using the direct current to constant-voltage charging a capacitor module;
driving an electric motor by electricity coming from the capacitor module;
replacing the activation rotational speed with a constant rotational speed, provided by the electric motor, as the input rotational speed.

13. The method for power generation according to claim 12, further comprising a motor controller, electrically connected to the capacitor module, to drive the electric motor.

14. The method for power generation according to claim 12, wherein the rotation assembly comprises an outer ring gear, five planetary gears, and a center gear.

15. The method for power generation according to claim 14, wherein the outer ring gear drives the planetary gears, and the planetary gears drive the center gear.

16. The method for power generation according to claim 14, wherein the center gear is disposed at a center of the outer ring gear.

17. The method for power generation according to claim 12, wherein the alternating current is three-phase alternating current.

18. The method for power generation according to claim 12, wherein the capacitor module comprises a power management circuit.

19. The method for power generation according to claim 12, wherein the capacitor module comprises a plurality of supercapacitors in series.

20. The method for power generation according to claim 12, further comprising voltage reduction for the direct current after converting the alternating current to the direct current.

21. The method for power generation according to claim 12, wherein the activation rotational speed is provided by an activation pull cord.
